(19) United States
(12) Patent Application Publication
(10) Pub. No.: US 2007/0010701 A1
(43) Pub. Date: Jan. 11, 2007

(54) Method for stabilization of hazardous wastes with dilute acid soluble and dilute acid semi-soluble agents

(76) Inventor: Keith Edward Forrester, Meredith, NH (US)

Correspondence Address: Keith E. Forrester, 78 Tracy Way, Meredith, NH, 03253, US

(21) Appl. No.: 11/451,032

(22) Filed: Jun. 12, 2006

Related U.S. Application Data
(60) Provisional application No. 60/698,229, filed on Jul. 11, 2005.

(51) Int. Cl. B09B 3/00

(52) U.S. Cl. 588/256

(57) ABSTRACT

This invention provides a method for stabilization of heavy metal bearing materials and wastes subject to acid and water leaching tests or leach conditions by addition of acid soluble or acid semi-soluble dry stabilizing agents such that the leaching potential is inhibited to desired levels and the material or waste is free flowing, more permeable, less weight and permits immediate handling and disposal or reuse. The resultant material or waste after stabilization is deemed suitable for on-site reuse, off-site reuse or disposal as RCRA non-hazardous waste.

### BACKGROUND OF THE INVENTION

Over the past thirty years, the potential and observed dangers of heavy metal bearing materials and waste exposure to humans and the environment has been the basis of extensive regulatory control. The leaching and transport of heavy metals into surface water bodies and groundwater is a grave concern because of the danger that the drinking water supplies and the environment will become contaminated. Heavy metal bearing materials and wastes, such as soils contaminated with industrial or commercial products or waste, paint residues, sludge, plating wastes, sediments, foundry dusts, casting sands, steel mill dusts, shredder residues, wire insulation, refuse incinerator flyash, incinerator bottom ash, scrubber residues from air pollution control devices such as cyclones, electrostatic precipitators and bag-house filter bags, may be deemed hazardous by the United States Environmental Protection Agency (U.S. EPA) pursuant to 40 C.F.R. Part 261 if containing certain soluble heavy metals above regulatory limits. Any solid waste can be defined as hazardous either because it is “listed” in 40 C.F.R., Part 261 Subpart D or because it exhibits one or more of the characteristics of a hazardous waste as defined at Part 261, Subpart C. These characteristics are: (1) ignitability, (2) corrosivity, (3) reactivity, and (4) toxicity as tested under the Toxicity Characteristic Leaching Procedure (TCLP). Heavy metal bearing materials and wastes can also be regulated under state and federal groundwater and surface water protection standards, which set total and leachable limits for heavy metals often lower than the TCLP criteria, as the wastes and materials are not in a lined landfill and exposed to direct groundwater, drinking water, storm waters and surface water bodies.

40 C.F.R., Part 261.24(a), contains a list of contaminants and their associated maximum allowable concentrations. The inorganic list includes As, Ag, Ba, Cd, Cr, Pb, Hg, and Se. If a contaminant exceeds its maximum allowable concentration, when tested using TCLP analysis as specified at 40 C.F.R. Part 261 Appendix 2, then the material is classified as hazardous. The TCLP test uses a dilute acetic acid either in de-ionized water (TCLP fluid 2) or in de-ionized water with a sodium hydroxide buffer (TCLP fluid 1). Both extracts attempt to simulate the leachate character from a decomposing trash landfill in which the hazardous waste being tested for is assumed to be disposed of in, and thus subject to the acetic acid leaching condition. Waste containing leachable heavy metals is currently classified as hazardous waste due to the toxicity characteristic, if the level of TCLP analysis is above 0.2 to 100 milligrams per liter (mg/L) or parts per millions (ppm) for defined metals. The TCLP test is designed to simulate a worst-case leaching situation, i.e., leachate which would typically be found in the interior of an actively degrading municipal landfill. Such landfills normally are slightly acidic with a pH of approximately 5+0.5. Countries outside of the US also use the TCLP test as a measure of leachability such as Taiwan, Philippines, Thailand, and Canada. Thailand also limits solubility of Cu and Zn, as these are metals of concern to Thailand groundwater. Switzerland and most European countries also regulate management of solid wastes by measuring heavy metals and salts as tested by a sequential leaching method using carbonated water simulating acid rainwater. Japan and the United Kingdom use similar carbonated DI water leach tests to measure for landfill leaching potential from heavy metals.

Additionally, U.S. EPA land disposal restrictions prohibit the land disposal of treated hazardous wastes that leach in excess of maximum allowable concentrations upon performance of the TCLP analysis. The land disposal regulations require that hazardous wastes are treated until the heavy metals do not leach at Universal Treatment Standard (UTS) levels from the solid waste at levels above the maximum allowable concentrations prior to placement in a surface impoundment, waste pile, landfill or other land disposal unit as defined in 40 C.F.R. 260.10.

Leach tests thus subject solid wastes including sludge, ash, residues, material or soil to dilute acetic acid leaching (TCLP), buffered citric acid leaching (STLC), distilled water, synthetic rainwater (SPLP, MEP) or carbonated water leaching (Japanese, UK, Swiss, and USEPA SW-924). Synthetic rainwater leach tests are also often used to measure heavy metal solubility and compare such to groundwater and surface water state and federal standards where materials and wastes are either reused on-site or disposed in a manner other than lined landfills.

Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered acetic acid for 18 hours. The extract solution is made up from 5.7 ml of glacial acetic acid and 64.3 ml of 1.0 normal sodium hydroxide up to 1000 ml dilution with reagent water.

Suitable synthetic acid leach tests include the USEPA SW-846 Manual described Synthetic Precipitant Leaching Procedure (SPLP) and Multiple Extraction Procedure Test (MEP) now used in the US for sites where wastes are reused outside of leachate collected and lined landfills. Briefly, in a SPLP test, 100 grams of waste are tumbled with 2000 ml of dilute nitric and sulfuric acid for 18 hours. The extract solution is made up to pH at near 4.8 simulating acid rainwater East and West of the Mississippi. The MEP is the Multiple Extraction Procedure which uses the TCLP type test for the first extract and followed by 9 cycles of the SPLP, all of which report leachate values, and thus attempt to measure diffusion potential of the waste matrix.

Suitable carbonated water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO2 saturated method is the Swiss protocol using 100 grams of cemented waste at 1 cm3 in two (2) sequential water baths of 2000 ml. The concentration of heavy metals and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The heavy metal concentration is then analyzed by Inductively-Coupled Plasma (ICP) after filtration of a 100 ml aliquot from the tumbler through a 45 micron glass bead filter.

Of specific interest and concern regarding the present invention is the leaching of individual heavy metal groups including As, Ag, Ba, Cd, Cr, Cu, Pb, Se, Hg, Sb, Ni, and Zn and combinations thereof under TCLP, SPLP, MEP, CALWET, acid rainwater and acid rain derived surface water conditions as well as non-landfill conditions such as open industrial sites, waste storage cells, waste piles, waste monofills and under regulatory tests which attempt to simulate dilute acid water leaching for determination of hazardousness of any given soil, material or waste.

The present invention provides a method of reducing the leachability of material or waste including the groups As, Ag, Ba, Cd, Cr, Pb, Hg, Se, Sb, Cu, Ni, Zn, and combinations thereof under TCLP, SPLP, MEP, CALWET, acid rainwater and acid rain derived surface water leaching conditions, with use of dilute acid-soluble or acid semi-soluble dry chemical “seeds” that minimize weight increase of the treated material or waste and permit immediate stabilized matrix management and handling without water application and mixing, without curing requirements and associated double handling required from interim storage piles, and while producing a free-flowing and more permeable stabilized material or waste suitable for excavator or loader loading, truck unloading and land disposal or immediate reuse spreading and compaction. The present invention recognizes the use of dilute acids as leaching fluids to which dry stabilizer will be added, and thus teaches use of stabilizers that are dilute acid soluble and semi-soluble.

Unlike the present invention, prior art has taught stabilization of heavy metals by addition of water soluble or water based physical encapsulation agents, and have failed to recognize the value of stabilizers which are not water soluble or have limited water solubility, yet are soluble in dilute acetic acid (TCLP), dilute sulfuric and nitric acid (SPLP/MEP) and dilute citric acid (CALWET). In particular, O'Hara (U.S. Pat. No. 4,737,356) and Forrester (U.S. Pat. Nos. 5,245,114 and 5,430,233) teach the need to add water soluble phosphates to incinerator ash, auto shredder and wire insulation wastes, and incinerator bottom ash, which are at least 5 gm/100 ml water solubility, with the preferred embodiment being 100% water soluble phosphoric acid. Prior art stabilization methods using Portland cement, lime, cement kiln dust, phosphoric acids, and combinations also produce a reduced permeability matrix or solid material form by adding water (by combination or as part of the water soluble agent addition) to the stabilization recipe for a chemical reaction which presents post-stabilization handling and disposal complications, whereas the present invention use of dry stabilizers acts to reduce metals solubility without significant reduction of permeability, without formation of cement-like non-free flowing material or waste, without curing time, without water hydration and associated material and waste weight increase, without double material and soil handling required for curing stockpiles, thus permitting immediate stabilizer material or waste handling, loading, disposal or reuse. The dry acid soluble and acid semi-soluble seed stabilization method operates on the basic principle that sufficient wet dilute acid environment contact and mixing between the material or waste and the stabilizer chemical(s) will occur within the TCLP, SPLP, MEP or CALWET extraction vessel. The extraction method(s) used to predict leaching potential all assume that field material or waste disposal conditions are subject to hydration by acid rainwater or acid leachate and involve some degree of interstitial mixing of heavy metals with the extract fluid over some minimal period of time in a saturated environment, and that such hydration can be simulated by an extract solute addition and mixing period. The seeding stabilization method thus utilizes the regulatory extraction procedure to allow for post-stabilized material or waste hydration, mixing and wet chemistry dilute acid environment contact between heavy metals and stabilizer seeds. The extraction tests thus act as dilute acid stirred tank reactors, which provide the opportunity for heavy metals on the surface of materials and waste, and that which diffuses into the acid solution, to have ample opportunity to contact stabilization seeds that also have surface active and/or soluble mineral formation potentials with the dilute acid soluble and/or available heavy metals. One unique benefit of the dry seed technology is that SPLP, MEP, TCLP and CALWET extract fluid acid soluble and acid semi-soluble dry stabilizers such as monocalcium phosphate, triple superphosphate, single superphosphate, dicalcium phosphate, tricalcium phosphate and ore phosphates, can be applied to waste or material and dry mixed for uniformity in the field, and consequently test samples of such stabilizers are allowed to freely tumble or mix in the presence of the heavy metals in the extract solution for a given extraction period of time. This non-cemented and non-reacted acid soluble and acid semi-soluble stabilizer surface mixing greatly improves the wet environment substitution of heavy metals such as Pb, Cd, Cr, Ni, and As into calcium phosphate apatite surfaces. The extraction device effectively puts the heavy metals into solution as well as acid soluble agent and semi-soluble agent into solution and thus provides an excellent opportunity for surface substitution, sorption and precipitation of now solution soluble heavy metals. Under this chemical mechanism, some or all stabilization agents are made available to the solution by the acid solution, and heavy metal ions are made available to the solution which in turn substitute and exchange for calcium on insoluble apatite surfaces and precipitate with stabilization agents in acid solution.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial wastewater contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

Unlike the present invention, however, none of the prior art solutions taught specific dilute acid soluble or semi-soluble dry seed stabilization of heavy metal bearing material or waste containing one or more heavy metals while also forming a free-flowing, more permeable stabilized matrix suitable for loading, transport, disposal and reuse without having a cement-like reduced permeability and strength, and without the burden of curing and associated double waste handling. Specifically, prior art has failed to teach the mechanism of acid soluble or acid semi-soluble dry seeding to allow intentional leaching of heavy metals into the regulatory extraction vessel and subsequent substitution of such metals onto stabilizer surfaces and precipitation and complex formation with stabilization agents in acid solution.

### SUMMARY OF THE INVENTION

The present invention discloses a heavy metal bearing material or waste stabilization method through contact of material or waste with acid soluble or semi-soluble dry seed stabilizing agents including Portland cement, cement kiln dust, lime kiln dust, monocalcium phosphates, tricalcium phosphates, dicalcium phosphates, calcium phosphates, single superphosphate, triple superphosphate, phosphate fertilizers, phosphate rock, phosphates, phosphate salts, dolomitic lime, limestone, lime, quicklime, silicates, sulfides, sulfates, carbonates, chlorides, bone phosphates, iron filings, iron powder, ferric chloride, ferrous sulfate, ferric sulfate and combinations thereof which are properly chosen to complement the material or waste leaching potential and desired free-flowing and more permeable material or waste handling characteristics without hydration, curing and associated additional waste or material interim storage, handling, transport, disposal costs. Of specific interest is the disclosure of a dry apatite stabilization means which provides for heavy metal stabilization by surface substitution into apatite mineral or by precipitation with acid soluble apatite minerals during the regulatory extraction procedure. The stabilizing agents proven effective are provided in dry chemical form, and thus can be contacted with heavy metal bearing material either prior to waste production such as in-stream at wastewater facilities producing sludge or in-duct prior to air pollution control and ash collection devices or after waste production in material collection devices or waste piles.

It is anticipated that the stabilizers can be used for both RCRA compliance actions such that generated wastes or materials from wastewater facilities, furnaces, incinerators and other facilities do not exceed the TCLP hazardous waste criteria under TCLP or CERCLA (Superfund) response where stabilizers are added to waste piles or storage vessels previously generated. The preferred method of application of stabilizers would be in-line within the property and facility generating the heavy metal bearing material, and thus allowed under RCRA as a totally enclosed, in-tank or exempt method of TCLP stabilization without the need for a RCRA Part B hazardous waste treatment and storage facility permit.

### DETAILED DESCRIPTION

Environmental regulations throughout the world such as those promulgated by the USEPA under RCRA and CERCLA require heavy metal bearing waste and material producers to manage such materials and wastes in a manner safe to the environment and protective of human health. In response to these regulations, environmental engineers and scientists have developed numerous means to control heavy metals, mostly through chemical applications which convert the solubility of the material and waste character to a low soluble form, thus passing leach tests and allowing the wastes to be either reused on-site or disposed at local landfills without further and more expensive control means such as hazardous waste disposal landfills or facilities designed to provide metals stabilization. The primary focus of scientists has been on singular heavy metals such as lead, cadmium, chromium, arsenic and mercury, as these were and continue to be the most significant mass of metals contamination in soils. Materials such as lead paints, incinerator ash, foundry and mill flyash, auto shredder and wire shredding residues and cleanup site wastes such as battery acids and slag wastes from smelters are major lead sources. Recently, however, there exists a demand for control methods of various heavy metals such as As, Ag, Ba, Cd, Cr, Pb, Cu, Sb, Se, Hg, Ni, and Zn and combinations thereof in mining waste, wastewater sludge, shredder wastes, wire insulation, incinerator flyash, incinerator bottom ash, incinerator combined ash, foundry dusts, steel mill dusts, and contaminated soils to meet TCLP and also SPLP, MEP, DI and other measures intended to measure field condition leaching and/or solubility of the metals under digestion, in a manner which is rapid, low cost, avoids interim storage and curing time, and permits on-site or off-site reuse and handling at moisture levels below or at optimium for compaction and handling.

The present invention discloses a heavy metal bearing material or waste stabilization method through contact of material or waste with dry “seed” acid soluble stabilizing agents including Portland cement, cement kiln dust, triple superphosphate, single superphosphate, phosphate salts, monocalcium phosphate, tricalcium phosphate, dicalcium phosphates, calcium phosphates, phosphate salts, phosphate rock, bone phosphate, phosphates, quicklime, dolomitic lime, lime, lime kiln dust, limestone, silicates, iron powder, iron filings, sulfides, sulfates, carbonates, ferrous sulfate, ferric sulfate, ferric chloride and combinations thereof. The acid soluble stabilizing agents found effective are available in dry form, and thus can be contacted with heavy metal bearing material prior to waste generation such as in-stream at wastewater sludge producing plants or in-duct prior to air pollution control and ash collection devices or after waste production in collection devices such as hoppers, dump valves, conveyors, dumpsters or waste piles. The stabilizers are applied dry, thus allowing stabilized material and waste to remain suitable for fill material or loose handling and to remain less permeable thus allowing for transmission of leachate or water flow. The transmission of water flow becomes important an necessary when using the stabilized waste or material as base fill, cover, embankment or engineered fill, thus eliminating damming or leachate production perched water table effects.

The acid soluble and acid semi-soluble dry seed stabilization method reduces the leachability of heavy metal bearing wastes including the groups As, Ag, Ba, Cd, Cr, Pb, Hg, Se, Sb, Cu, Ni, Zn, and combinations thereof under TCLP, SPLP, MEP, CALWET, DI, rainwater and surface water leaching conditions as well as under regulatory water extraction test conditions as defined by waste control regulations in UK, Thailand, Japan, Switzerland, Germany, Sweden, the Netherlands and under American Nuclear Standards for sequential leaching of wastes, with use of acid soluble and acid semi-soluble dry chemical stabilizer “seeds” to minimize weight increase of the treated waste and permit immediate stabilized matrix management and handling without curing requirements or double handling required for interim storage, and producing a free-flowing and more permeable stabilized material or waste suitable for excavator or loader loading, truck unloading and land disposal or immediate reuse spreading and compaction.

The present invention provides a method of reducing the leachability of material or waste including the groups As, Ag, Ba, Cd, Cr, Pb, Hg, Se, Sb, Cu, Ni, Zn, and combinations thereof under TCLP, SPLP, MEP, CALWET, acid rainwater and acid rain derived surface water leaching conditions, with use of dilute acid-soluble or acid semi-soluble dry chemical “seeds” that minimize weight increase of the treated material or waste and permit immediate stabilized matrix management and handling without water application and mixing, without curing requirements and associated double handling required from interim storage piles, and while producing a free-flowing and more permeable stabilized material or waste suitable for excavator or loader loading, truck unloading and land disposal or immediate reuse spreading and compaction. The present invention recognizes the use of dilute acids as leaching fluids to which dry stabilizer will be added, and thus teaches use of stabilizers that are dilute acid soluble and semi-soluble.

Unlike the present invention, prior art has taught stabilization of heavy metals by addition of water soluble or water based physical encapsulation agents, and have failed to recognize the value of stabilizers which are not water soluble or have limited water solubility, yet are soluble in dilute acetic acid (TCLP), dilute sulfuric and nitric acid (SPLP/MEP) and dilute citric acid (CALWET). In particular, O'Hara (U.S. Pat. No. 4,737,356) and Forrester (U.S. Pat. Nos. 5,245,114 and 5,430,233) teach the need to add water soluble phosphates to incinerator ash, auto shredder and wire insulation wastes, and incinerator bottom ash, which are at least 5 gm/100 ml water solubility, with the preferred embodiment being 100% water soluble phosphoric acid. Prior art stabilization methods using Portland cement, lime, cement kiln dust, phosphoric acids, and combinations also produce a reduced permeability matrix or solid material form by adding water (by combination or as part of the water soluble agent addition) to the stabilization recipe for a chemical reaction which presents post-stabilization handling and disposal complications, whereas the present invention use of dry stabilizers acts to reduce metals solubility without significant reduction of permeability, without formation of cement-like non-free flowing material or waste, without curing time, without water hydration and associated material and waste weight increase, without double material and soil handling required for curing stockpiles, thus permitting immediate stabilizer material or waste handling, loading, disposal or reuse. The dry acid soluble and acid semi-soluble seed stabilization method operates on the basic principle that sufficient wet dilute acid environment contact and mixing between the material or waste and the stabilizer chemical(s) will occur within the TCLP, SPLP, MEP or CALWET extraction vessel. The extraction method(s) used to predict leaching potential all assume that field material or waste disposal conditions are subject to hydration by acid rainwater or acid leachate and involve some degree of interstitial mixing of heavy metals with the extract fluid over some minimal period of time in a saturated environment, and that such hydration can be simulated by an extract solute addition and mixing period. The seeding stabilization method thus utilizes the regulatory extraction procedure to allow for post-stabilized material or waste hydration, mixing and wet chemistry dilute acid environment contact between heavy metals and stabilizer seeds. The extraction tests thus act as dilute acid stirred tank reactors, which provide the opportunity for heavy metals on the surface of materials and waste, and that which diffuses into the acid solution, to have ample opportunity to contact stabilization seeds that also have surface active and/or soluble mineral formation potentials with the dilute acid soluble and/or available heavy metals. One unique benefit of the dry seed technology is that SPLP, MEP, TCLP and CALWET extract fluid acid soluble and acid semi-soluble dry stabilizers such as monocalcium phosphate, triple superphosphate, single superphosphate, dicalcium phosphate, tricalcium phosphate and ore phosphates, can be applied to waste or material and dry mixed for uniformity in the field, and consequently test samples of such stabilizers are allowed to freely tumble or mix in the presence of the heavy metals in the extract solution for a given extraction period of time. This non-cemented and non-reacted acid soluble and acid semi-soluble stabilizer surface mixing greatly improves the wet environment substitution of heavy metals such as Pb, Cd, Cr, Ni, and As into calcium phosphate apatite surfaces. The extraction device effectively puts the heavy metals into solution as well as acid soluble agent and semi-soluble agent into solution and thus provides an excellent opportunity for surface substitution, sorption and precipitation of now solution soluble heavy metals. Under this chemical mechanism, some or all stabilization agents are made available to the solution by the acid solution, and heavy metal ions are made available to the solution which in turn substitute and exchange for calcium on insoluble apatite surfaces and precipitate with stabilization agents in acid solution.

It is anticipated that the stabilizers can be used for both RCRA compliance actions such that generated materials from mining operations, wastewater facilities, furnaces, incinerators and other facilities do not exceed appropriate TCLP hazardous waste criteria under TCLP, or used for CERCLA (Superfund) response where stabilizers are added to waste piles or storage vessels previously generated and now regulated under RCRA as a hazardous waste pre-disposal. The preferred method of application of stabilizers would be in-line within the property and facility generating the heavy metal bearing material, and thus allowed under RCRA as a totally enclosed, in-tank or exempt method of TCLP stabilization without the need for a RCRA Part B hazardous waste treatment and storage facility permit(s).

The use of Portland cement, cement kiln dust, lime kiln dust, silicates, lime, dolomitic lime, magnesium oxide, quicklime, phosphates, lime, ferric sulfate, ferrous sulfate, ferric chloride, iron powder, iron filings, chlorides, carbonates, monoammonia phosphate (MAP), diammonium phosphate (DAP), single superphosphate (SSP), triple superphosphate (TSP), hexametaphosphate (HMP), tetrapotassium polyphosphate, dicalcium phosphate, tricalcium phosphate, monocalcium phosphate, phosphate rock, pulverized forms of all above dry phosphates, and combinations thereof would, as an example, provide various amount of dry stabilizer with material or waste. In certain cases such as with triple superphosphate, one dry stabilizer may provide several additives such as iron, aluminum and other complexing agents which could also provide for a single-step formation of complexed minerals. The stabilizer combination type, size, dose rate, contact duration, and application means could be engineered for each type of heavy metal bearing material or waste.

Although the exact stabilization formation molecule(s) are unknown at this time, it is expected that when heavy metals comes into contact with the dry acid soluble or semi-soluble stabilizing agent(s) in the presence of extraction fluids used during the extraction analyses, compound(s) begin to form such as a mineral phosphate, twinned mineral, hydroxyapatites, hydroxides, sulfide precipitates, ferric substitutes, mononuclear silicate layers or precipitate through substitution or surface bonding, which is less soluble than the heavy metal element or molecule originally in the material or waste. Specifically complexing and/or twinning of Pb, As, Cr, Ni, Cu, Zn and Cd into pyromorphite and calcium apatites most likely occurs by adding calcium phosphate(s) to the material or waste and within the extractor fluids at standard temperature and pressure. It also remains possible that modifications to temperature and pressure may accelerate of assist formation of minerals, although such methods are not considered optimal for this application given the need to limit cost and provide for optional field based stabilizing operations that would be complicated by the need for pressure and temperature control devices and vessels.

In another method, heavy metal bearing material or waste is contacted with at least one dry phosphate in the presence of a complexing agent selected to generate specific mineral on the heavy metal bearing material or waste. The complexing agent could include iron, aluminum, calcium, chlorides, sulfates, vanadium, and various other complexing agents which provide for or assist in formation of TCLP and other leach test low solubility minerals. Use of phosphates in the presence of complex agents for mineral formations of lead bearing wastes is taught by U.S. Pat. No. 5,722,928 issued to Forrester.

Examples of suitable stabilizing agents include, but are not limited to, Portland cement, cement kiln dust, lime kiln dust, quicklime, hydrated lime powder, limestone, carbonates, sulfides, sulfates, iron filings, iron powder, ferric sulfate, ferrous sulfate, ferric chloride, phosphate fertilizers, phosphate rock, pulverized phosphate rock, calcium orthophosphates, monocalcium phosphate, dicalcium phosphate, tricalcium phosphate, trisodium phosphates, calcium oxide (quicklime), dolomitic quicklime, silicates, sodium silicates, potassium silicates, natural phosphates, dry phosphoric acids, hypophosphoric acid, metaphosphoric acid, hexametaphosphate, tertrapotassium polyphosphate, polyphosphates, trisodium phosphates, pyrophosphoric acid, fishbone phosphate, animal bone phosphate, herring meal, bone meal, phosphorites, and combinations thereof. Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

The amounts of stabilizing agent used, according to the method of invention, depend on various factors including desired solubility reduction potential, desired mineral toxicity, and desired mineral formation relating to toxicological and site environmental control objectives. It has been found that an amount of certain stabilizing agents such as 0.5% dicalcium phosphate by weight of incinerator bottom ash waste is sufficient for initial TCLP stabilization to less than RCRA limits. However, the foregoing is not intended to preclude yet higher or lower usage of stabilizing agent or combinations if needed since it has been demonstrated that amounts greater than 15% cement kiln dust and phosphate by weight also work, but are more costly. The examples below are merely illustrative of this invention and are not intended to limit it thereby in any way.

### EXAMPLE 1

In this example Chromium contaminated wet clay soil was stabilized with varying amounts of TCLP fluid acetic acid soluble stabilizing agents including quicklime (QL) and dicalcium phosphate (DCP) with zero (0) days of sample curing pre-TCLP extraction. Both stabilized and un-stabilized soil was subsequently tested for TCLP Cr. Samples were extracted according to TCLP procedure set forth in Federal Register, Vol. 55, No. 126, pp. 26985-26998 (Jun. 29, 199), which is hereby incorporated by reference. The leachate was digested prior to analysis by ICP. Lime and phosphate mixtures produced free flowing soil suitable for land disposal, passed the paint filter test, with less than 20 PSI unconfined strength and permeability increase from baseline untreated soils of 1.27×10E-5 cm.sec to a final stabilized 3.5×10E-3 for lime and phosphate blend recipe.

TABLE 1

| Stabilizer Dose (%) | TCLP Cr (ppm) |
|---|---|
| 0 | 130 (Unworkable wet saturated clay) |
| 8% QL | 26 (Workable fine dry clay) |
| 2% DCP | 1.7 (Semi-wet clay) |
| 8% QL + 2% DCP | <0.05 (workable coarse grain clay) |

### EXAMPLE 2

In this example industrial metals processing sludge was stabilized with varying amounts of TCLP fluid acetic acid soluble stabilizing agents including triple superphosphate (TSP), Portland cement type A/B (PC), cement kiln dust (CKD), and high calcium quicklime (QL), with zero (0) days of sample curing pre-extraction. Both stabilized and un-stabilized sludge were subsequently tested for TCLP Pb, Cd, As, Cr. The leachate was digested prior to analysis by ICP. Stabilized sludge was measured with less than 50 PSI unconfined strength. Permeability of a final lime, cement kiln dust and TSP blend was measured at 6.4×10-4 cm/sec versus the sludge baseline of 7.3×10E-5. All stabilized samples passed the paint filter test.

TABLE 2

| Stabilizer Dose (%) | TCLP Pb—Cd—As—Cr (ppm) |
|---|---|
| 0 | 23-3.2-1-2 |
| 5 PC + 5 TSP | 0.05-1.4-0.5-0.4 |
| 5 PC + 5 QL | 17-0.05—0.05—0.05 |
| 5 CKD + 5 QL + 2 TSP | 0.05—0.05—0.05—0.05 |

### EXAMPLE 3

In this example Chromium and Lead bearing paint residue was stabilized with TCLP fluid acetic acid soluble dicalcium phosphate (DCP) with zero (0) days of sample curing pre-TCLP extraction. Both stabilized and un-stabilized residue was subsequently tested for TCLP Cr and Pb. Samples were extracted according to TCLP procedure set forth in Federal Register, Vol. 55, No. 126, pp. 26985-26998 (Jun. 29, 199), which is hereby incorporated by reference. The leachate was digested prior to analysis by ICP. DCP mixtures produced free flowing residue suitable for land disposal, passed the paint filter test, with less than 20 PSI unconfined strength.

TABLE 3

| Stabilizer Dose (%) | TCLP Cr/Pb (ppm) |
|---|---|
| 0 | 6.4/3.5 |
| 1% DCP | 0.38/0.05 |
| 2% DCP | 0.16/0.05 |

### EXAMPLE 4

In this example Cadmium, Chromium, Arsenic, Nickel and Lead bearing plating waste contaminated soil was stabilized with TCLP fluid acetic acid soluble dicalcium phosphate (DCP), Triple Superphosphate (TSP), Cement Kiln Dust (CKD) and dolomitic quicklime (QL) with zero (0) days of sample curing pre-TCLP extraction. Both stabilized and un-stabilized residue was subsequently tested under TCLP and SPLP. DCP and quicklime mixtures produced free flowing residue suitable for land disposal, passed the paint filter test, with less than 50 PSI unconfined strength.

TABLE 4

| | TCLP | SPLP |
|---|---|---|
| Stabilizer Dose (%) | Cd/As/Cr/Ni/Pb (ppm) | Cd/As/Cr/Ni/Pb (ppm) |
| 0% DCP | 7.3/NT (Not tested) | 4.2/NT |
| 1% TSP | 8.2/NT | 9.1/NT |
| 1% DCP + 15 CKD | 0.097/ND | ND |
| 1% DCP + 5% QL | ND (Non-detectable) | ND |

### EXAMPLE 5

In this example refuse incinerator bottom ash was stabilized with varying amounts of TCLP fluid acetic acid soluble stabilizing agents including triple superphosphate (TSP) and dicalcium phosphate (DCP) with zero (0) days of sample curing pre-TCLP extraction. Both stabilized and un-stabilized bottom ash was subsequently tested for TCLP Pb. Samples were extracted according to TCLP procedure set forth in Federal Register, Vol. 55, No. 126, pp. 26985-26998 (Jun. 29, 199), which is hereby incorporated by reference. The leachate was digested prior to analysis by ICP. Phosphate mixtures produced free flowing ash suitable for land disposal, passed the paint filter test, with less than 20 PSI unconfined strength.

TABLE 5

| Stabilizer Dose (%) | TCLP Pb (ppm) |
|---|---|
| 0 | 10.3 |
| 1% DCP | <0.05 (workable coarse ash) |
| 1% TSP | <0.05 (workable coarse ash) |

### EXAMPLE 6

In this example refuse incinerator flyash and scrubber residue was stabilized with varying amounts of TCLP fluid acetic acid soluble stabilizing agents including triple superphosphate (TSP) and dicalcium phosphate (DCP) with zero (0) days of sample curing pre-TCLP extraction. Both stabilized and un-stabilized bottom ash was subsequently tested for TCLP Pb. Samples were extracted according to TCLP procedure set forth in Federal Register, Vol. 55, No. 126, pp. 26985-26998 (Jun. 29, 199), which is hereby incorporated by reference. The leachate was digested prior to analysis by ICP. Phosphate mixtures produced free flowing ash suitable for land disposal, passed the paint filter test, with less than 20 PSI unconfined strength.

TABLE 6

| Stabilizer Dose (%) | TCLP Pb (ppm) |
|---|---|
| 0 | 80.7 |
| 5% DCP | <0.05 (workable fine ash) |
| 5% TSP | <0.05 (workable fine ash) |

### EXAMPLE 7

In this example refuse incinerator combined ash was stabilized with varying amounts of TCLP fluid acetic acid soluble stabilizing agents including triple superphosphate (TSP) and dicalcium phosphate (DCP) with zero (0) days of sample curing pre-TCLP extraction. Both stabilized and un-stabilized bottom ash was subsequently tested for TCLP Pb. Samples were extracted according to TCLP procedure set forth in Federal Register, Vol. 55, No. 126, pp. 26985-26998 (Jun. 29, 199), which is hereby incorporated by reference. The leachate was digested prior to analysis by ICP. Phosphate mixtures produced free flowing ash suitable for land disposal, passed the paint filter test, with less than 20 PSI unconfined strength.

TABLE 7

| Stabilizer Dose (%) | TCLP Pb (ppm) |
|---|---|
| 0 | 35.3 |
| 5% DCP | <0.05 (workable coarse ash) |
| 5% TSP | <0.05 (workable coarse ash) |

### EXAMPLE 8

In this example refuse and medical waste incinerator flyash and scrubber residue was stabilized with varying amounts of TCLP fluid acetic acid soluble stabilizing agents including triple superphosphate (TSP) and dicalcium phosphate (DCP) with zero (0) days of sample curing pre-TCLP extraction. Both stabilized and un-stabilized bottom ash was subsequently tested for TCLP Pb. Samples were extracted according to TCLP procedure set forth in Federal Register, Vol. 55, No. 126, pp. 26985-26998 (Jun. 29, 199), which is hereby incorporated by reference. The leachate was digested prior to analysis by ICP. Phosphate mixtures produced free flowing ash suitable for land disposal, passed the paint filter test, with less than 20 PSI unconfined strength.

TABLE 8

| Stabilizer Dose (%) | TCLP Pb (ppm) |
|---|---|
| 0 | 8.3 |
| 10% DCP | 0.24 (workable coarse ash) |
| 10% TSP | <0.05 (workable coarse ash) |

The foregoing results in Table 1 thru 8 readily established the operability of the present process to dry stabilize metals thus reducing solubility, measured acid leachability and bioavailability, while also producing wastes suitable for handling and disposal without curing time. Given the effectiveness of the stabilizing agents in causing heavy metals to stabilize as presented in the Table 1 thru 8, it is believed that an amount of the stabilizing agents equivalent to less than 10% by weight of heavy metal bearing material or waste should be effective. It is also apparent from the Table 1, 2, 3 and 4 that certain stabilizing agents and complexing blends are more effective for stabilization.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the solubility of heavy metal bearing material or waste, comprising contacting heavy metal bearing material or waste with at least one dry acid soluble or acid semi-soluble stabilizing agent in an amount effective in reducing the leaching of combined heavy metals from the material or waste to a level no more than non-hazardous levels as determined in an EPA TCLP test, performed on the stabilized material or waste, as set forth in the Federal Register, vol. 55, no. 126, pp. 26985-26998 (Jun. 29, 1990).

2. The method of claim 1, wherein the stabilizing agent is selected from the group consisting of phosphates, cement kiln dust, lime kiln dust, Portland cement, silicates, quicklime, lime, phosphates, ferric sulfate, ferrous sulfate, ferric chloride and mineral complexing agent combinations, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

3. The method of claim 2, wherein the salts of phosphoric acid are alkali metal salts.

4. The method of claim 2, wherein the phosphate salt is a trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

5. The method of claim 2, wherein the phosphate and complexing agent as iron, calcium, chloride, or aluminum are supplied as one product including triple superphosphate and combination fertilizer mixtures.

6. The method of claim 2, wherein the stabilizing complexing agents are selected from polymer, calcium chloride, sodium chloride, potassium chloride, vanadium, boron, iron, aluminum, sulfates, sulfides or combinations thereof.

7. The method of claim 1 wherein As, Ag, Ba, Cd, Cr, Pb, Se, Hg, Sb, Cu, Ni and Zn bearing material or waste is contacted with at least one (1) stabilizing agent in effective amount to reduce leaching to TCLP non-hazardous or desired levels prior to collection of such material or waste in containers.

8. The method of claim 1 wherein As, Ag, Ba, Cd, Cr, Pb, Se, Hg, Sb, Cu, Ni and Zn bearing material or waste is contacted with at least one (1) stabilizing agent in effective amount to reduce leaching to TCLP non-hazardous or desired levels during or after collection of such material or waste in containers or during or after generation of material or waste as a regulated waste.

9. The method of claim 1 wherein the material of waste includes incinerator ash, incinerator bottom ash, incinerator combined ash, incinerator flyash, incinerator scrubber residue, shredder waste, shredder fluff, wire shredder insulation, contaminated soils, foundry sand, steel mill flyash, slag, smelter ash, lead smelter ash, foundry flyash, lead projectiles, lead projectile berm material, lead paint residue.

10. A method of reducing the solubility of combined heavy metal bearing material or waste, comprising contacting heavy metal bearing material or waste with at least one acid soluble or acid semi-soluble dry stabilizing agent in an amount effective in reducing the leaching of combined heavy metals from the material or waste to a level no more than non-hazardous or non-acceptable levels as determined in SPLP, MEP, United Kingdom DI, Japan DI or Swiss sequential water leach test, performed on the stabilized material or waste.

11. The method of claim 10, wherein the stabilizing agent is selected from the group consisting of phosphates, cement kiln dust, Portland cement, silicates, lime, phosphates, ferric chloride and mineral complexing agent combinations, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

12. The method of claim 1 wherein As, Ag, Ba, Cd, Cr, Pb, Se, Hg, Sb, Cu, Ni, and Zn bearing incinerator ash, foundry dust, smelter ash, smelter slag, shredder fluff, wire insulation, steel mill ash, is contacted with at least one (1) stabilizing agent in effective amount to reduce leaching to non-hazardous or desired levels prior to collection of such waste or materials in containers.

13. The method of claim 10 wherein As, Ag, Ba, Cd, Cr, Pb, Se, Hg, Sb, Cu, Ni, and Zn bearing incinerator ash, foundry dust, smelter ash, smelter slag, steel mill ash, shredder fluff, wire insulation, is contacted with at least on stabilizing agent in effective amount to reduce leaching to non-hazardous or desired levels during or after collection of such waste or material in containers or during or after generation as a regulated waste.

14. A method of reducing the solubility of combined heavy metal bearing material or waste, comprising contacting heavy metal bearing material or waste with at least one dry extract insoluble stabilizing agent in an amount effective in reducing the leaching of combined heavy metals from the material or waste to a level no more than non-acceptable levels as determined by a regulatory test using such extract.

15. The method of claim 14, wherein the stabilizing agent is selected from the group consisting of phosphate rock, bone phosphate, fishbone phosphates, monocalcium phosphate, dicalcium phosphate, tricalcium phosphate and combinations thereof.

16. The method of claim 14, wherein the extract fluid is selected from methods TCLP, SPLP, EP Tox, MEP, DI, Japan DI, Swiss sequential, and Europe sequential and acceptable levels are defined as hazardous, groundwater or surface water specific allowable levels.
